(19) United States
(12) Patent Application Publication
(10) Pub. No.: US 2025/0287190 A1
(43) Pub. Date: Sep. 11, 2025

(54) Wearable Safety Device and System for Emergency Services in Large Crowded Places

(71) Applicant: Miah Dejohn, Fort Wayne, IN (US)

(72) Inventor: Miah Dejohn, Fort Wayne, IN (US)

(21) Appl. No.: 19/060,945

(22) Filed: Feb. 24, 2025

Related U.S. Application Data
(60) Provisional application No. 63/563,032, filed on Mar. 8, 2024.

(51) Int. Cl. H04W 4/90; G08B 25/01; H04B 1/3827; H04W 4/029

(52) U.S. Cl. CPC H04W 4/90; G08B 25/016; H04B 1/385; H04W 4/029

(57) ABSTRACT

A wearable device and a crowd safety system for enhancing safety and medical assistance to individuals in crowded events is disclosed. The wearable device is equipped with a transceiver, a biosensor, a location module, and an SOS button, enabling the wearer to transmit an SOS signal containing location and/or vital signs information to a server. The server is configured to analyze the received SOS signal and transmits alerts to medical and security modules for prompt assistance to the wearer. The wearable device is adaptable as various forms of jewelry or accessories and features a unique identification user ID for efficient wearer identification during emergencies. The present invention assists security and medical staff by quickly notifying and locating an individual who may be in need of assistance.

### CROSS-REFERENCE TO RELATED APPLICATION

The present application claims priority to, and the benefit of, U.S. Provisional Application No. 63/563,032, which was filed on Mar. 8, 2024, and is incorporated herein by reference in its entirety.

### FIELD OF THE INVENTION

The present invention generally relates to the field of safety devices. More specifically, the present invention relates to a wearable tracking system for emergency services in large and crowded places. The wearable tracking system comprises a wearable device to track individuals in a crowded space. The wearable device can be integrated into a wristband, a necklace, or any other design. The wearer can press an SOS button to alert security and/or medical staff for assistance. Accordingly, the present disclosure makes specific reference thereto. Nonetheless, it is to be appreciated that aspects of the present invention are also equally applicable to others like applications, devices, and methods of manufacture.

### BACKGROUND

By way of background, individuals enjoy going to concerts, live events, public parties, and more. In certain cases, such as in the case when an elderly person attends a music concert or visits any such crowded space, there are chances of getting lost or injured. There could be numerous reasons due to which chaos can be created and someone in the crowd could even get hurt. Such as, in the case of a missing person, especially if any child is missing, an atmosphere of anxiety or fear arises. Further, aged individuals may have a medical condition that can be triggered due to overcrowded spaces and the person can feel suffocated during the event and need immediate medical assistance.

While in a crowd, a person may be pushed, squeezed, pulled, or even trampled or crushed. A person may panic or faint from overheating or a lack of oxygen. A person in a crowd may be pushed or shoved and may put his/her life at risk for a wide variety of injuries such as broken bones, bruising, brain injuries, dental injuries, and other similar injuries.

One of the conventional methods used for individuals' safety is monitoring by the organizing staff. Generally, the staff patrols within the crowd manually and using surveillance cameras, and the patrolling enables the staff to observe individuals' vitals, identify signs of distress, and sense the atmosphere/tension, which is useful information for supervisors and other key decision-makers. However, the method requires a lot of manpower and is expensive and inefficient.

Currently, there are many crowd monitoring tools with various software that use different technology, such as Artificial intelligence, Bluetooth, Wi-Fi, etc., to monitor location and medical condition of individuals/crowds in a large, crowded event. However, such crowd monitoring tools are highly expensive, complex to set up, and need professional support.

Therefore, there exists a long-felt need in the art for a safety system that can be used for the safety of individuals at an event or large crowd space. There is also a long-felt need in the art for a wearable device that can efficiently notify the location and/or medical condition of a wearer in the crowd at an event. Additionally, there is a long-felt need in the art for a wearable tracking system that can provide information regarding medical conditions of a wearer sensed by biosensors. Further, there is a long-felt need in the art for a device that can be worn by individuals at an event and helps in locating the wearer and play out an alarm for alerting the emergency services. Furthermore, there is a long-felt need in the art for a safety system that uses wearable devices to assist security and medical staff by quickly notifying and locating an individual who needs assistance. Finally, there is a long-felt need in the art for a wearable tracking device for emergency services in crowded places that is efficient and ensures safety of wearers of the event.

The subject matter disclosed and claimed herein, in one embodiment thereof, comprises a wearable device for crowd safety. The device includes a control module including a transceiver, a biosensor, a GPS module, and a speaker, an SOS button coupled to the control module, wherein upon activation (i.e., actuation) of the SOS button by a wearer sends an SOS signal via the transceiver to a server, the SOS signal comprising the location of the wearer detected by the GPS module and vital signs information detected by the biosensor, and the server alerts a security team and a medical team for providing assistance to the wearer.

In this manner, the crowd safety wearable tracking system and the wearable device of the present invention accomplish all of the foregoing objectives and provide wearers with a safety wearable device that helps in locating the wearer at an event such as a crowded space and plays out an alarm for alerting the emergency services provide. The wearable device can be designed into a wristband, a necklace, or any other design. The device provides GPS location and vital information of the wearer to security and medical staff which helps in providing immediate assistance to the wearer in large and crowded places. The system can be adapted for various other wearable devices like necklaces or anklets, making the system adaptable to accommodate requirements of different users.

### SUMMARY OF THE INVENTION

The following presents a simplified summary in order to provide a basic understanding of some aspects of the disclosed innovation. This summary is not an extensive overview, and it is not intended to identify key/critical elements or to delineate the scope thereof. Its sole purpose is to present some general concepts in a simplified form as a prelude to the more detailed description that is presented later.

The subject matter disclosed and claimed herein, in one embodiment thereof, comprises a wearable device for providing an SOS signal in case of an emergency. The device further comprises a control module including a transceiver, a biosensor, a location module, and a speaker, an SOS button coupled to the control module, wherein upon activation (i.e., actuation) of the SOS button by a wearer sends an SOS signal via the transceiver to a server, the SOS signal comprising the location of the wearer detected by the location module, and the server alerts a security team and a medical team for providing assistance to the wearer.

In another embodiment, a wearable device for crowd safety is disclosed. The device includes a control module including a transceiver, a biosensor, a GPS module, and a speaker, an SOS button coupled to the control module, wherein upon activation (i.e., actuation) of the SOS button by a wearer sends an SOS signal via the transceiver to a server, the SOS signal comprising the location of the wearer detected by the GPS module and vital signs information detected by the biosensor, and the server alerts a security team and a medical team for providing assistance to the wearer.

In another aspect, a crowd safety system is disclosed. The system includes a server configured to communicate with a medical module and a security module, at least one wearable device adapted to be worn by an individual at an event, the wearable device including a transceiver for sending a signal to the server via a wireless communication channel, wherein the signal comprises an SOS signal and the location information of the wearable device, wherein the server is further configured to send alerts to the medical module and/or the security module based on the signal received from the wearable device, and wherein the wearable device is configured to compare vital signs information of the wearer with pre-defined threshold values and includes a unique identification user ID to identify the wearer in case of emergencies.

In yet another aspect, the wearable tracking system includes at least one wearable device in communication with a server via a communication channel. The server further sends to a medical module or a security module alerting that a wearer may need immediate attention. The wearable device is connected to the communication channel to send/receive signals to the server.

In another aspect, each wearable device is tagged with a unique identification user ID to identify the wearer at the time of emergency. The unique identification user ID of the wearer helps the security module and the medical module to identify the identity of the wearer who has sent the SOS signal from the crowd.

In another aspect, a method for operating a wearable safety device for providing immediate assistance to a wearer of the device is described. The method includes the steps of detecting, by a biosensor within the wearable device, vital signs of a wearer and comparing the detected vital signs with pre-defined threshold values, activating, by the wearer, an SOS button on the wearable device to send an SOS signal to a server, the SOS signal comprising the wearer's location determined by a GPS module and the vital signs information, and transmitting, by the server, an alert to a medical module and a security module for immediate response.

Numerous benefits and advantages of this invention will become apparent to those skilled in the art to which it pertains upon reading and understanding of the following detailed specification.

To the accomplishment of the foregoing and related ends, certain illustrative aspects of the disclosed innovation are described herein in connection with the following description and the annexed drawings. These aspects are indicative, however, of but a few of the various ways in which the principles disclosed herein can be employed and are intended to include all such aspects and their equivalents. Other advantages and novel features will become apparent from the following detailed description when considered in conjunction with the drawings.

### BRIEF DESCRIPTION OF THE DRAWINGS

The description refers to provided drawings in which similar reference characters refer to similar parts throughout the different views, and in which:

FIG. 1 illustrates a schematic diagram of the wearable device tracking system of the present invention for safety of individuals at an event in accordance with disclosed architecture;

FIG. 2 illustrates a perspective front view of one embodiment of the wearable device used for alerting the security or medical services in accordance with disclosed structure;

FIG. 3 illustrates a rear perspective view of the wearable device of FIG. 2 in accordance with one embodiment of the present invention;

FIG. 4 illustrates a block diagram showing components included in the control module of the wearable device of FIG. 2 in accordance with one embodiment of the present invention;

FIG. 5 illustrates a flow diagram depicting a process for operating the wearable device in accordance with the disclosed architecture;

FIG. 6 illustrates a flowchart depicting a process of alerting security/medical services to provide assistance to a wearer of the wearable device in accordance with the disclosed architecture;

FIG. 7 illustrates a flow diagram depicting a process for checking and comparing the vital information by the biosensor for automatic SOS signal in accordance with the disclosed architecture; and

FIG. 8 illustrates another embodiment of the safety wearable device of the present invention in accordance with the disclosed structure.

### DETAILED DESCRIPTION OF THE PRESENT INVENTION

The innovation is now described with reference to the drawings, wherein like reference numerals are used to refer to like elements throughout. In the following description, for purposes of explanation, numerous specific details are set forth in order to provide a thorough understanding thereof. It may be evident, however, that the innovation can be practiced without these specific details. In other instances, well-known structures and devices are shown in block diagram form in order to facilitate a description thereof. Various embodiments are discussed hereinafter. It should be noted that the figures are described only to facilitate the description of the embodiments. They are not intended as an exhaustive description of the invention and do not limit the scope of the invention. Additionally, an illustrated embodiment need not have all the aspects or advantages shown. Thus, in other embodiments, any of the features described herein from different embodiments may be combined.

As noted above, there exists a long-felt need in the art for a safety system that can be used for the safety of individuals at an event or large crowd space. There is also a long-felt need in the art for a wearable device that can efficiently notify the location and/or medical condition of a wearer in the crowd at an event. Additionally, there is a long-felt need in the art for a wearable tracking system that can provide information regarding medical conditions of a wearer sensed by biosensors. Further, there is a long-felt need in the art for a device that can be worn by individuals at an event and helps in locating the wearer and play out an alarm for alerting the emergency services. Furthermore, there is a long-felt need in the art for a safety system that uses wearable devices to assist security and medical staff by quickly notifying and locating an individual who needs assistance. Finally, there is a long-felt need in the art for a wearable tracking device for emergency services in crowded places that is efficient and ensures safety of wearers of the event.

The present invention, in one exemplary embodiment, discloses a method for operating a wearable safety device for providing immediate assistance to a wearer of the device. The method includes the steps of detecting, by a biosensor within the wearable device, vital signs of a wearer and comparing the detected vital signs with pre-defined threshold values, activating, by the wearer, an SOS button on the wearable device to send an SOS signal to a server, the SOS signal comprising the wearer's location determined by a GPS module and the vital signs information, and transmitting, by the server, an alert to a medical module and a security module for immediate response.

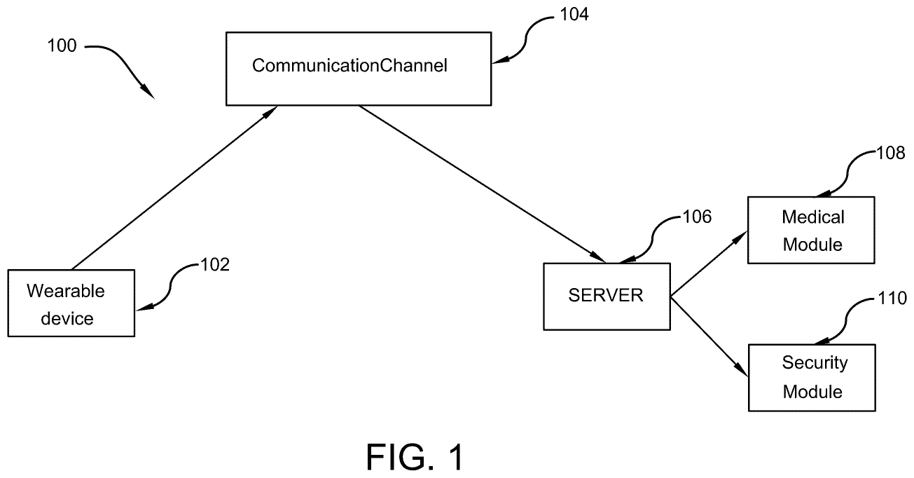

Referring initially to the drawings, FIG. 1 illustrates a schematic diagram of the wearable device tracking system of the present invention for safety of individuals at an event in accordance with the disclosed architecture. The crowd safety system 100 is designed to provide safety and immediate assistance to individuals at an event or crowded place by providing security and medical personnel. The system 100 includes at least one specially designed wearable device 102 which is adapted to be worn by an individual at an event. The wearable device 102 is a safety device and communicates with a server 106 via a communication channel 104. The communication channel 104 is preferably a wireless communication channel. The server 106 is configured to further send alerts to a medical module 108 and/or a security module 110 based on the signal received from the wearable device 102. The server 106 is preferably a local server for managing communication from the wearable devices worn by individuals at the event.

The wearable device 102 is connected to the communication channel 104 to send a signal to the server 106 via a transceiver. The signal is an SOS signal and can include the location information (i.e., inside a campus where the event is taking place) of the device 102. The SOS signal in some embodiments can also include vital signs information of the wearer of the wearable device 102. The device 102 also compares the vital signs information of the wearer with the pre-defined threshold values for the vital signs.

The server 106 is adapted to communicate with the medical module 108 and the security module 110. The server 106 is preferably a combination of hardware and software that provides functionality or services to the medical module 108 and the security module 110. The medical module 108 can be integrated into the server or can also be standalone devices or integrated into smartphones, smart tablets, and smartwatch navigation systems of the on-site medical personnel to interpret the signals to determine the precise location and vital signs of the wearer of the device 102 from which the signals were received by the server 106. The medical module 108 may be operated by a first aid team to help the wearer. The security module 110 can be integrated into the server or can also be standalone devices or integrated into smartphones, smart tablets, and smartwatch navigation systems to interpret the signals to determine the precise location of the wearer. The security module 110 may be operated by the wearer locator team for detecting the exact location of the wearer.

In the preferred embodiment, the wearable device 102 is designed as a wristband. However, the design of the wearable device 102 is not limited and can be designed as a necklace, anklet, armband, chest band, or any other wearable device and can be designed in any shape or can be available in other designs as per the requirements of the users.

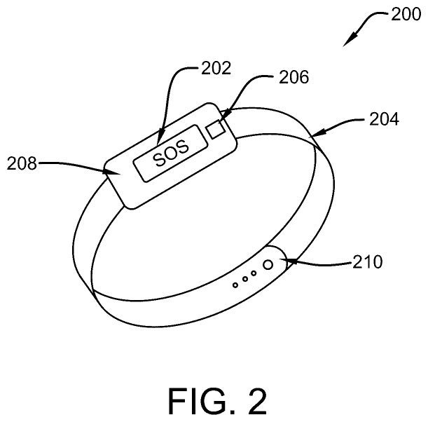

In one embodiment, the wearable device 102 can be tagged or configured with a unique identification user ID to identify the wearer associated with the device 102 at the time of emergency. For example, if the wearer is lost in an event, an SOS button (illustrated in FIG. 2) may get manually activated (i.e., actuated) by the wearer. The device transmits the location signal to the server 106. The unique identification user ID of the wearer may help the medical module 108 and/or security module 110 to identify the user. The device 102 can be provided along with a ticket to a user attending an event and can be associated with a fee which can be refunded after returning the device 102. Alternatively, the device 102 can be purchased and configured for different events by an individual.

The communication channel 104 can be associated with a data standard which may be defined by one of a Local Area Network (LAN), a Personal Area Network (PAN), a Wireless Local Area Network (WLAN), a Wireless Sensor Network (WSN), Wireless Area Network (WAN), Wireless Wide Area Network (WWAN), a metropolitan area network (MAN), a satellite network, the Internet, a fiber optic network, a coaxial cable network, an infrared (IR) network, a radio frequency (RF) network, and a combination thereof. Embodiments of the present invention are intended to include or otherwise cover any type of communication channel, including known, related art, and/or later developed technologies.

The server 106 is configured to have the logic, instructions, circuitry, interfaces, and/or codes for executing various operations required for communication between the server 106 and the wearable device 102 and also between the modules 108, 110, and the server 106.

FIG. 2 illustrates a perspective front view of one embodiment of the wearable device used for alerting the security or medical services in accordance with the disclosed structure. As shown in the present embodiment, the wearable safety device 200 is in the form of a wristband. It should be noted that the wearable device 200 is referred to as 102 in FIG. 1 of the present disclosure. The wearable device 200 is designed to be worn like a bracelet or a watch and includes a SOS Button 202. The wearable alert device 200 is secured around the wrist of a user using a strap or band 204 which is flexible and forms a closed loop via a clasp 210.

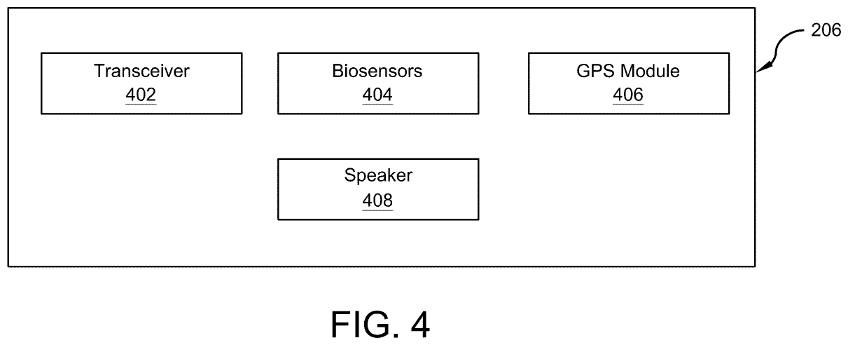

The wearable device 200 is adapted to detect the location of the wearer of the device 200 at an event (i.e., using the GPS module 406, FIG. 4) and send the location to the server 106. The SOS button 202 is preferably embedded on the front dial 208 of the device 200 for easy accessibility. The SOS button 202 can be a physical push button or a touch button and functions as a trigger which when activated (i.e., such as by pressing) by the wearer of the device 200 and sends an SOS signal to the server 106 indicating that the wearer is in distress or an emergency situation.

A control module 206 is installed in the wearable device 200 and includes different electronic components of the device 200 and the SOS button 202 when pressed activates the control module 206 to send the SOS signal to the server 106. The control module 206 includes a transceiver 402, a biosensor 404, a GPS module 406, and a speaker 408. The components have been further explained in detail in FIG. 4.

The strap 204 can be made using a material selected from leather, metal, ceramic, silicone, rubber nylon, and textile. The wearable device 200 can come in different colors, designs, and sizes to accommodate requirements of users of all ages and genders. Further, the wearable device 200 is lightweight, weatherproof, and skin-friendly.

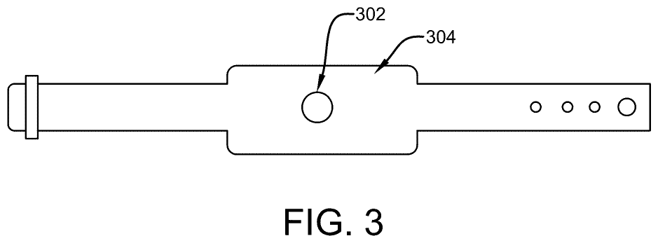

FIG. 3 illustrates a rear perspective view of the wearable device of FIG. 2 in accordance with one embodiment of the present invention. The rear surface 304 of the dial 208 of the wearable device 200 has a power source 302. The power source 302 provides electrical power for operating the device 200 efficiently. The power source can be button cells, also known as button batteries or coin cells. In some embodiments, the power source 302 is solar-powered and provides an environmentally friendly battery. The power source 302 is preferably both rechargeable and replaceable for improving longevity of the device 200.

FIG. 4 illustrates a block diagram showing components included in the control module of the wearable device of FIG. 2 in accordance with one embodiment of the present invention. As illustrated, the control module 206 includes a transceiver 402, a biosensor 404, a GPS module 406, and a speaker 408. The control module 206 is coupled to the SOS button 202 and is activated when the SOS button 202 is pressed by a user. The control module 206 using the transceiver 402 transmits the in-venue location (detected by the location module 406) and the vital signs information (detected by biosensor 404) of the wearer of the device 200 to the server 106. Based on the vital signs information, the server 106 may send an alert to the medical module 108 along with the security module 110. In some embodiments, the server 106 is configured to transmit the alert to both the medical module 108 and the security module 110 simultaneously. The transceiver 402 enables the device 200 to communicate using the communication channel 104. The transceiver 402 facilitates seamless connectivity and communication in various applications, ranging from telecommunications and networking to consumer electronics and industrial automation.

In one example, in case an individual is lost at an event and presses the SOS button 202, the location and/or the vital signs information of the individual is received by the server 106 in an SOS signal and the security module 110 receives an alert from the server 106. Once the security module 110 receives the location and identity of the person, a security team can instantly reach the location to the track and safeguard the individual. The speaker 408 may play out an alarm when the SOS button 202 is pressed to alert surrounding individuals of an emergency situation. When the vital signs are above or below a pre-set threshold, the medical module 108 can also be alerted to send medical assistance. In some embodiments, the medical module 108 and the security module 110 can be embodied as a single module. In yet another example, in case a person is injured at an event and the SOS button 202 is pressed, both the medical module 108 and the security module may receive an alert from the server 106.

The biosensor 404 tracks physiological parameters such as heart rate and provides insights into the wearer's overall health and well-being at an event. In some embodiments, the biosensor 404 can also monitor blood oxygen (SpO₂). The biosensor 404 can determine changes in vitals according to pre-defined threshold values for automatically generating an alert signal for transmission to the server 106. In some embodiments, the wearable device 200 may include a beacon or any other short-range location detection technology for detecting the location of the device 200 inside a campus.

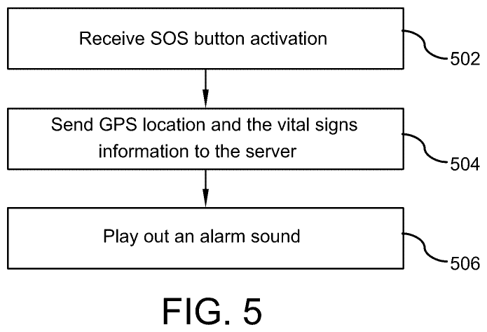

FIG. 5 illustrates a flow diagram depicting a process for operating the wearable device 200 in accordance with the disclosed architecture. At step 502, the wearable device 200 receives SOS button activation when a wearer presses and/or holds the SOS button 202. The SOS button then activates the control module 206 to send an SOS signal to the server 106.

At step 504, the location of the wearer and the vital signs of the wearer are sent to the server 106. The information is used by the server to send a medical team and/or security team to the wearer. At step 506, when the location information and the vital signs information are sent to the server, an alarm sound is played by the speaker 408 for alerting the surrounding users. In some embodiments, the alarm may be played when a security or medical personnel detects the location of the wearer.

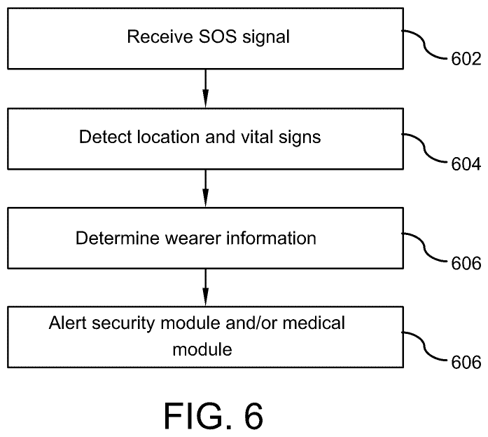

FIG. 6 illustrates a flowchart depicting a process of alerting security/medical services to provide assistance to a wearer of the wearable device in accordance with the disclosed architecture. At step 602, the server 106 receives an SOS signal sent by the device 200 upon pressing the SOS button 202. At step 604, the server 106 receives the GPS location and vital information in the SOS signal. At step 606, the server 106 determines the wearer's details such as name and unique identification user ID. The wearer details help in identification of the wearer of the wearable device. Finally, at step 608, based on the received vital signs information, the medical module and the security module are alerted by the server for sending the medical team and the security team.

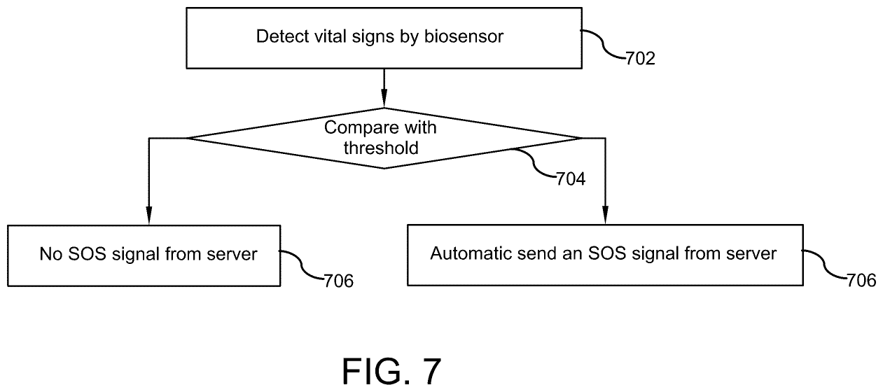

FIG. 7 illustrates a flow diagram depicting a process for checking and comparing the vital information by the biosensor for automatic SOS signal in accordance with the disclosed architecture. At step 702, the vital information of the wearer is detected by the biosensor 404. The control module 206 compares the detected vital signs with the pre-defined threshold value of vital signs information (Step 704). It should be noted that the pre-defined vital signs information threshold can be different for different wearable devices and can depend on the age and gender of the wearer to reduce false positives. If the detected vital information lies within the pre-defined threshold value, then NO automatic SOS signal is sent to the server (Step 706). If the vital information is outside the predefined threshold value, then an automatic SOS alert is sent to the server 106 (Step 706)

The various actions, acts, blocks, steps, or the like in the flow diagram may be performed in the order presented, in a different order, or simultaneously. Further, in some embodiments, some of the actions, acts, blocks, steps, or the like may be omitted, added, modified, skipped, or the like without departing from the scope of the invention.

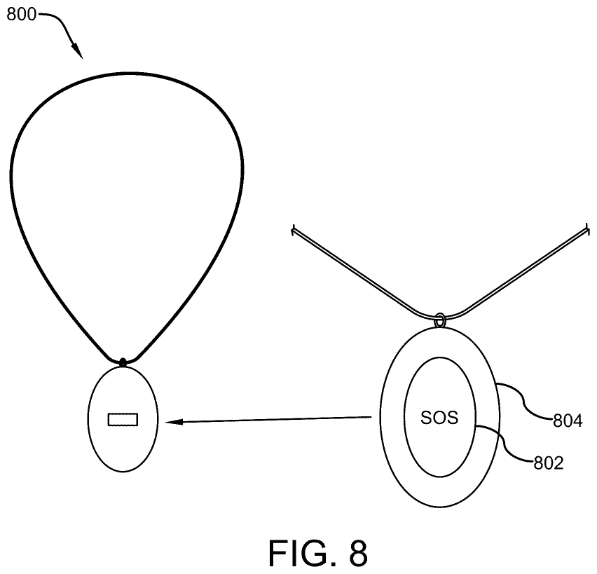

FIG. 8 illustrates another embodiment of the safety wearable device of the present invention in accordance with the disclosed structure. In the present embodiment, the safety wearable device 800 is in the form of a necklace and includes the SOS button 802 in the form of a pendant 804. All other specifications of the device 800 remains the same as of the described devices 102, 200.

Although particular embodiments of the invention have been described in detail for purposes of illustration, various modifications, and enhancements may be made without departing from the spirit and scope of the invention.

Certain terms are used throughout the following description and claims to refer to particular features or components. As one skilled in the art will appreciate, different persons may refer to the same feature or component by different names. This document does not intend to distinguish between components or features that differ in name but not structure or function. As used herein “wearable GPS tracking system”, “crowd safety system”, and “system” are interchangeable and refer to the crowd safety wearable device system 100 of the present invention. Similarly, as used herein, “wearable device”, “wearable safety device”, “wearable alert device”, and “device” are interchangeable and refer to the wearable safety device 102, 200, 800 of the present invention.

Notwithstanding the foregoing, the crowd safety wearable device system 100 and the wearable safety device 102, 200, 800 of the present invention can be of any suitable size and configuration as is known in the art without affecting the overall concept of the invention, provided that they accomplish the above-stated objectives. One of ordinary skill in the art will appreciate that the crowd safety wearable device system 100 and the wearable safety device 102, 200, 800 as shown in the FIGS. are for illustrative purposes only, and that many other sizes and shapes of the crowd safety wearable device system 100 and the wearable safety device 102, 200, 800 are well within the scope of the present disclosure. Although the dimensions of the crowd safety wearable device system 100 and the wearable safety device 102, 200, 800 are important design parameters for user convenience, the crowd safety wearable device system 100 and the wearable safety device 102, 200, 800 may be of any size that ensures optimal performance during use and/or that suits the user's needs and/or preferences.

Various modifications and additions can be made to the exemplary embodiments discussed without departing from the scope of the present invention. While the embodiments described above refer to particular features, the scope of this invention also includes embodiments having different combinations of features and embodiments that do not include all of the described features. Accordingly, the scope of the present invention is intended to embrace all such alternatives, modifications, and variations as fall within the scope of the claims, together with all equivalents thereof.

What has been described above includes examples of the claimed subject matter. It is, of course, not possible to describe every conceivable combination of components or methodologies for purposes of describing the claimed subject matter, but one of ordinary skill in the art may recognize that many further combinations and permutations of the claimed subject matter are possible. Accordingly, the claimed subject matter is intended to embrace all such alterations, modifications, and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A crowd safety system for directing security and medical personnel, the crowd safety system comprising:
a wearable device;
a server;
a communication channel;
a medical module; and
a transceiver;
wherein said wearable device worn by an individual;
wherein said wearable device communicates with said server through said communication channel;
wherein said communication channel is a wireless communication channel;
wherein said server sends alerts to said medical module based on a first signal received from said wearable device;
wherein said server is a local server;
wherein said wearable device connected to said communication channel for sending said alert to said server through said transceiver;
wherein said alert is an SOS signal;
wherein said alert having a location information for identifying a location of said wearable device;
wherein said SOS signal having a plurality of vital signs of a wearer of said wearable device; and
further wherein said plurality of vital signs compared to a plurality of pre-defined threshold values for said plurality of vital signs.

2. The crowd safety system for directing security and medical personnel of claim 1 further comprising a security module, wherein said server sends alerts to said security module based on a second signal received from said wearable device.

3. The crowd safety system for directing security and medical personnel of claim 2, wherein said server communicates to said medical module and to said security module.

4. The crowd safety system for directing security and medical personnel of claim 3, wherein said wearable device is selected from the group consisting of a wristband, a necklace, an anklet, an armband, and a chest band.

5. The crowd safety system for directing security and medical personnel of claim 4, wherein said wearable device having a unique user ID to identify the wearer associated with said wearable device.

6. The crowd safety system for directing security and medical personnel of claim 5, wherein said wearable device having a GPS module transmitting the location to said server.

7. The crowd safety system for directing security and medical personnel of claim 6, wherein said alert is a wearer actuated alert button.

8. A crowd safety system for directing security and medical personnel comprising, the crowd safety system comprising:
a wearable device;
a server;
a communication channel;
a medical module; and
a transceiver;
wherein said wearable device worn by an individual;
wherein said wearable device communicates with said server through said communication channel;
wherein said communication channel is a wireless communication channel;
wherein said server sends alerts to said medical module based on a first signal received from said wearable device;
wherein said server is a local server;
wherein said wearable device connected to said communication channel for sending said alert to said server through said transceiver;
wherein said alert is an SOS signal;
wherein said alert having a location information for identifying a location of said wearable device;
wherein said wearable device is selected from the group consisting of a wristband, a necklace, an anklet, an armband, and a chest band;
wherein said wearable device having a unique user ID to identify the wearer associated with said wearable device;
wherein said wearable device having a GPS module transmitting the location to said server;
and
further wherein said alert is a wearer actuated alert button.

9. The crowd safety system for directing security and medical personnel of claim 8, wherein said SOS signal having a plurality of vital signs of a wearer of said wearable device.

10. The crowd safety system for directing security and medical personnel of claim 9, wherein said plurality of vital signs compared to a plurality of pre-defined threshold values for said plurality of vital signs.

11. The crowd safety system for directing security and medical personnel of claim 10 further comprising a security module, wherein said server sends alerts to said security module based on a second signal received from said wearable device.

12. The crowd safety system for directing security and medical personnel of claim 11, wherein said server communicates to said medical module and to said security module.

13. A method of detecting an alert and directing security and medical personnel, the method comprising the steps of:
providing a wearable device, a server, a communication channel, a medical module, a biosensor, and a transceiver, wherein said server is a local server, further wherein said wearable device connected to said communication channel for sending an alert to said server through said transceiver;
wearing said wearable device by a wearer;
communicating said wearable device with said server through said communication channel, wherein said communication channel is a wireless communication channel;
reading a plurality of vital signs of the wearer with said biosensor;
comparing said plurality of vital signs to a plurality of pre-defined threshold values for said plurality of vital signs of the wearer; and
sending said alert to said medical module with said server based on at least one reading of said plurality of vital signs outside of said pre-defined threshold values for said plurality of vital signs.

14. The method of detecting an alert and directing security and medical personnel of claim 13, wherein said alert having a location information for identifying a location of said wearable device.

15. The method of detecting an alert and directing security and medical personnel of claim 14 further comprising a security module, wherein said server sends another alert to said security module based on a wearer actuated signal received from said wearable device.

16. The method of detecting an alert and directing security and medical personnel of claim 15, wherein said server communicates to said medical module and to said security module.

17. The method of detecting an alert and directing security and medical personnel of claim 16, wherein said wearable device is selected from the group consisting of a wristband, a necklace, an anklet, an armband, and a chest band.

18. The method of detecting an alert and directing security and medical personnel of claim 17, wherein said wearable device having a unique user ID to identify the wearer associated with said wearable device.

19. The method of detecting an alert and directing security and medical personnel of claim 18, wherein said wearable device having a GPS module transmitting said location to said server.

20. The method of detecting an alert and directing security and medical personnel of claim 19, wherein said another alert is a manually actuated button on said wearable device.
